(19) United States
(12) Patent Application Publication
(10) Pub. No.: US 2008/0320535 A1
(43) Pub. Date: Dec. 25, 2008

(54) Ip-Enabled Terminal for Combined Video-Based Entertainment and Communication Services

(75) Inventors: Joseph Huybrighs, Laakdal (BE); Patrik Schoenenberger, Goseau (CH); Stefan Under, Unterhaching (DE)

Correspondence Address: BELL, BOYD & LLOYD, LLP, P.O. BOX 1135, CHICAGO, IL, 60690, US

(73) Assignee: Siemens Aktiengesellschaft

(21) Appl. No.: 10/587,703

(22) PCT Filed: Jan. 10, 2005
(86) PCT No.: PCT/EP2005/050077

§ 371 Date: Sep. 11, 2008

(30) Foreign Application Priority Data
Jan. 29, 2004 (DE) 10 2004 004 605.0

(51) Int. Cl. H04N 7/173

(52) U.S. Cl. 725/109; 725/114

(57) ABSTRACT

An IP-enabled terminal for combined video-based entertainment and communication services is provided. Hardware and software components are integrated into one terminal to support video-based communication and entertainment services.

### CROSS REFERENCE TO RELATED APPLICATIONS

This application is the US National Stage of International Application No. PCT/EP2005/050077, filed Jan. 10, 2005 and claims the benefit thereof. The International Application claims the benefits of German application No. 102004004605.0 DE filed Jan. 29, 2004, both of the applications are incorporated by reference herein in their entirety.

### FIELD OF INVENTION

The present invention relates to an IP-enabled terminal for combined video-based entertainment and communication services.

### BRIEF DESCRIPTION OF THE DRAWINGS

FIG. 1 illustrates an exemplary front and back view of an STB in accordance with the present invention;

FIG. 2 illustrates an exemplary hardware concept of an STB in accordance with the present invention;

FIG. 3 illustrates an exemplary software client architecture of an STB in accordance with the present invention; and

FIG. 4 illustrates an exemplary application of an STB in accordance with the present invention.

### DETAILED DESCRIPTION OF INVENTION

There is currently great market interest in video-based services that can be offered to broadband subscribers, e.g. with an ADSL or VDSL connection. DSL technology enables a steadily growing number of users to bring video-based services into the living room. The definition of video-based services is that a substantial part of the information is transmitted in the form of video data. Apart from the transmission of pure video films, there is also great interest in providing video-based added value services.

The IP-enabled terminal or Set Top Box (STB) described according to the invention integrates all hardware (HW) and software (SW) components in order to enable both the transmission of video films and video-based communication services.

Current solutions for video-based solutions via broadband connections offer either pure video entertainment services or video-based communication services such as, for example, video telephony. Thus STBs are known which only support video streaming or STBs which only support video telephony. Integrated STBs which can support both service categories were not known to date.

The STB according to the invention integrates all hardware and software components in one terminal to support at least one video-based communication service and at least one video-based entertainment service. Broadband access at the user's home and the broadband network infrastructure are prior art. The STB according to the invention does not make any specific demands in this regard as described in further detail below.

Such a combined STB permits the use of a wide range of video-based services. The following list provides a few examples of services:

Video on Demand/Pay Per View/Staggered Video/Digital Video Broadcast:

These are essentially services which supply video data as a constant IP stream to the STB.

Internet over TV/Walled Garden:

Pages in HTML format are displayed on the TV set.

Video Telephony:

In parallel with voice connection via IP (VoIP) both subscribers can see themselves on the TV set connected to the STB. A camera (STB integrated/connected) records the video information.

Instant Messaging/Chat:

The TV set serves as a display device for received or transmitted text messages which are instantaneously exchanged between two or more subscribers. Text is input e.g. via an infrared (IR) keyboard.

Receipt/Sending of SMS:

The TV set serves as a display device for received or sent SMS messages. SMS are transferred between the video network and the mobile network via suitable transition servers (gateways). Text is input, for example, via an infrared (IR) keyboard.

E-mail:

The STB serves as an e-mail client and enables the sending and receipt of e-mails. Moving or fixed images can also be attached via the connected video camera. Text is input, for example, via an infrared (IR) keyboard.

Personal Video Recorder:

The hard disk integrated into the STB permits the recording of TV broadcasts in digital format.

Games:

Games can be loaded onto the STB locally or played online with other players. The connection of an external games console to the STB is also possible.

Typically, the STB is connected to a TV set and uses this as an output device for all video information. For video-based communication services and in particular, for video telephony, the STB has a video camera for recording moving images of the subscriber.

The following list describes the essential hardware components and connection options of the STB according to the invention:

Video Camera (integrated, external connection possible, no external cables): For recording moving images.

Hard disk (integrated, can be connected externally, no external cables): For storing video data.

Controller/DSP/Motherboard: Contains all the components to process the video data (e.g. processors, ASICs, passive components, memory chips). As no STB controller chips which also support video encoding (which, for example, is necessary for video telephony) are currently available, an additional DSP (Digital Signal Processor) is employed. In this way, flexibility for future coding methods (e.g. Windows Media 9) is also achieved.

Power supply (integrated, external)
DSL connection/modem: Optionally the DSL modem can be integrated or external. For receipt or transmission of data via DSL. Integration of the STB into the IP network via PPPoE, i.e. STB is assigned the IP address via PPPoE and Radius Server

TV connection: For connection to the TV. The connection is typically dependent on the country, e.g. SCART, S-Video

Telephone connection: In order for the telephone terminal

to be used for voice transmission of video telephony,
the terminal can be directly connected to the STB. Optionally the STB can also have a hands-free device (microphone and loudspeaker included).

Keyboard connection (external connection possible, no external cables): For entering text information, e.g. for Instant Messaging.

Ethernet connection: To connect a personal computer (PC) so that any data can be exchanged via DSL at the same time as transmission of video data by means of PC, e.g. Internet surfing.

Remote control (no external cables): To control services, e.g. selection of services, leaf through pages, fast forward films, etc.

PCMCIA slot (integrated): To insert PCMCIA cards, e.g. WLAN card.

Smartcard reader (integrated, external): To use Smartcards for certain services, e.g. to read codes when using encoding methods.

Memory card reader (integrated, external): To read or store data from or on external standard memory cards, such as e.g. Memory Stick, CompactFlash Card.

Loudspeaker (internal): To transmit acoustic signals, e.g. when receiving an e-mail message.

Indicator lamp (internal): To transmit optical signals, e.g. when receiving an e-mail message.

TV/cable tuner (internal): To connect a cable to standard broadcast TV channels. These can then be recorded, for example, by means of an internal hard disk. Furthermore, a cable tuner also permits parallel image within an image display of cable TV signals and video on demand TV signals.

USB connection: To connect peripheral devices, e.g. joystick for games which run on the STB.

An exemplary embodiment of an STB according to the invention is described in further detail below.

The software architecture on the STB integrates various software components which support parallel use of video-based entertainment and communication services. The principle here is that various applications for communication services and entertainment services can run in parallel on a shared operating system (e.g. Linux). The software architecture permits the use of shared software components such as, for example, audio and video codecs for decoding or coding corresponding IP data streams. All software components are connected to an integrated software client and loaded into the STB.

An exemplary embodiment of an STB software client according to the invention is described in further detail below.

Previously mentioned hardware/software components are not all mandatory components of the STB according to the invention. It is essential, however, that at least one component which supports a communication service (such as, for example, video camera, telephone terminal, codecs for video/audio coding, video telephony application) and at least one component which supports an entertainment service (such as Electronic Program Guide Browser, codecs for video/audio decoding, video on demand application) are integrated into an STB.

The primary advantage of the STB according to the invention is that an attractive bundle of innovative, video-based services can be offered via the domestic TV set. Video-based entertainment services can thus be supplemented by attractive communication services. The TV set is suitable both as a screen for video telephony and also as an input/output device for e-mails.

Current solutions would require that the user connected two separate STB to his TV set to use video-based entertainment and communication services or that communication services only ran via the PC. Use of the TV set incl. STB also permits the use of communication services in the living room. This also makes it possible for service providers to canvass new customer groups with these services.

An integrated STB also permits the use of integrated services such as, for example, the sending of e-mails between other users in the same integrated video network.

Furthermore, use of the service can be optimized, e.g. by prioritizing services which are started via the STB Client by means of a corresponding client application. This is possible as all services are controlled by a shared STB Client and besides the TV set, the PC is also connected to the STB for Internet use.

The use of a commercial STB controller chip in conjunction with an audio/video DSP for the hardware concept meets all the requirements for video services and communication services. The STB controller chips currently available contain only decoder algorithms for video signals. For video telephony, however, encoder algorithms are also required (for the image of the video telephony subscriber to be sent). However, these can easily be loaded onto a DSP. For applications in DSL networks (see example in 5.3) with low bandwidths (e.g. 1.5 Mbit/s in the direction of the subscriber) it is necessary to support the latest decoder/encoder algorithms, such as MPEG 4/10 or Windows Media 9. STB controller chips for video services with these decoder algorithms are not yet available today. Future STB controller chips will no doubt support these decoder algorithms, but in all probability not the encoder algorithms.

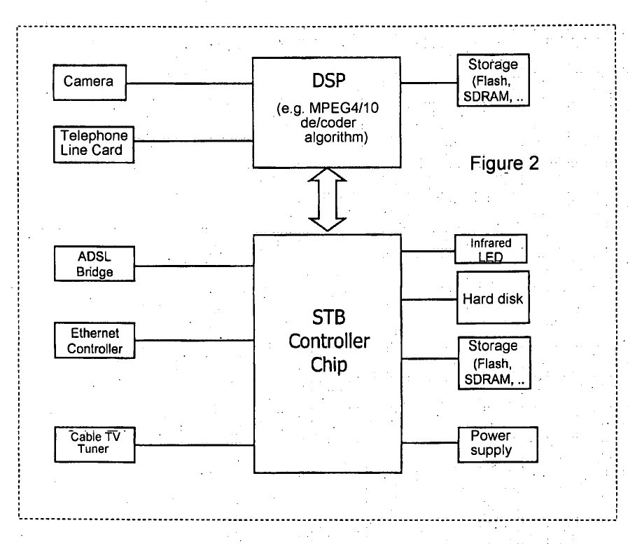

The hardware concept according to the invention of combining an STB controller chip with a DSP therefore already makes it possible to realize the STB according to the invention with existing STB controller chips. The DSP assumes all decoder/encoder tasks for video services and video telephony. The necessary decoder/encoder algorithms for this are simply loaded into the DSP (see also FIG. 2).

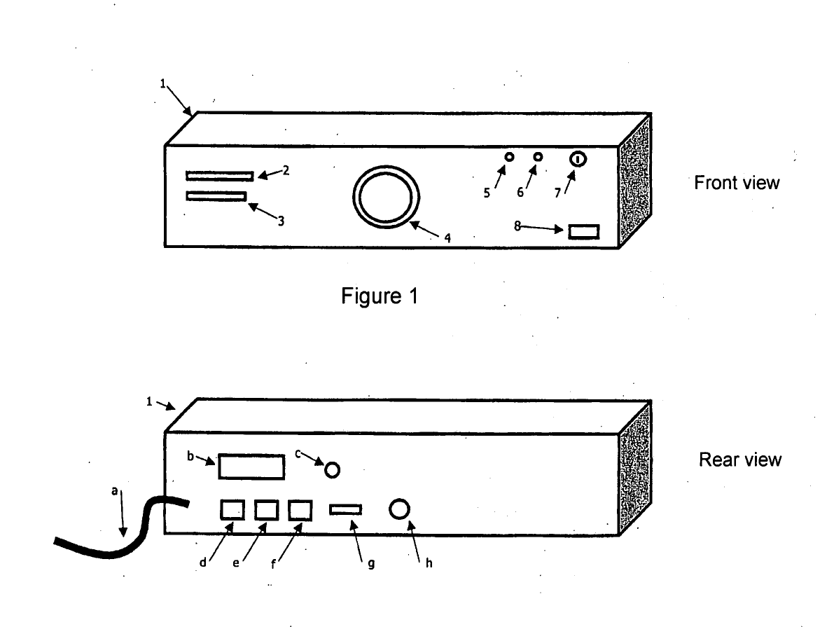

FIG. 1 shows an example of an STB according to the invention. This does not contain all the components listed in paragraph [0009]. In addition to the visible components, it is assumed that the following are also integrated into the STB: Hard disk, DSL modem, power supply unit. The legend for FIG. 1 follows.

### Legend for FIG. 1 (Front View):

1. Housing
2. PCMCIA slot
3. CompactFlash Card slot
4. Camera (integrated)
5. Indicator lamp
6. Operational status indicator
7. Network/standby switch
8. IR receiver

### Legend for FIG. 2 (Rear View):

1. Housing
a. Network cable
b. SCARTjack
c. Cable connection
d. Ethernet connection
e. Telephone terminal connection
f. Telephone connection (a/b)
g. USB
h. External keyboard

FIG. 2 shows an example of the hardware concept of the STB according to the invention. This does not contain all the components listed in paragraph [0009].

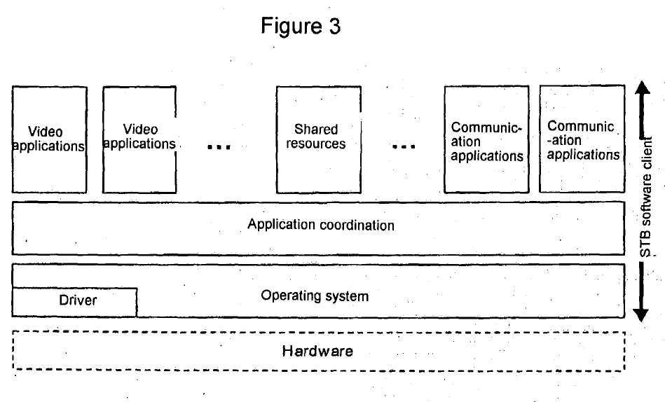

FIG. 3 shows an exemplary embodiment of STB software client architecture according to the invention.
Operating system: Shared operating system, for example, Linux or an MS Windows version.
Driver: software to control hardware components, e.g. an integrated hard disk.
Application coordination: This layer contains software parts which enable the various applications to work together in a coordinated manner. This layer may, for example, contain a Java Virtual Machine.
Video applications: Applications to control video-based entertainment services such as, for example, video on demand.
Communication applications: Applications to control video-based communication services such as, for example, video telephony. These may, for example, contain signaling stacks (H.323, SIP) or e-mail client applications.
Shared resources: This layer contains software components which can be used by all applications, e.g. codecs (MPEG 2, MPEG 4/10, H.263)

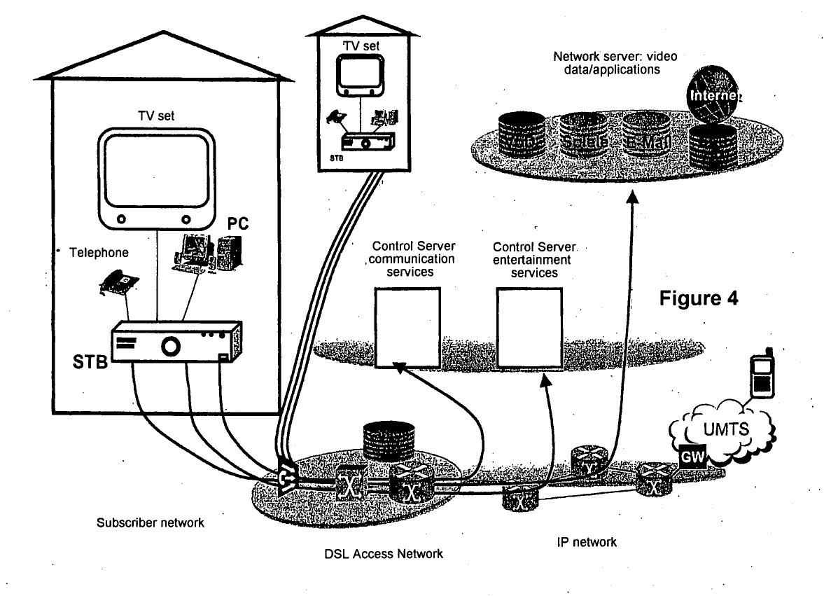

An application example for the method according to the invention is shown in FIG. 4.

The simplified example shows a combined, video-based application of entertainment and communication services based on ADSL infrastructure. Normal PSTN telephony is via fixed telephone networks. The example described here is a video service network (“overlay network”) overlaid on the telephone network.

The subscriber network is at the user's house. The IP-based data streams enter the DSL network via the STB. TV set, PC and telephone terminal are connected to the STB. The telephone terminal can be used for completely normal PSTN telephone conversations (via standard DSL splitter) or for voice over IP telephone conversations for the voice component of video telephony. As a general variation of the subscriber network, a completely wireless solution is possible, i.e. all terminals are connected to each other via suitable radio-based signaling technologies such as, for example, DECT, wireless LAN, Bluetooth, IR.

The DSL Access Network contains the standard components for ADSL such as DLAM, concentrator, BRAS and Radius database.

In the network there are control servers for entertainment services and for communication services. Both have a signaling relationship with STB. For the control server for entertainment services, this can be, for example, HTTP or Java/XML-based. For the control server for communication services this can be, for example, SIP or H.323-based. Both servers can also have a signaling relationship with each other, e.g. for shared user authentication (“single sign-on”).

This application example permits primary video telephony between subscribers of the video service network. Via an appropriate gateway, in principle, it is also possible to support video telephone calls with subscribers from other networks, e.g. UMTS subscribers. Compatible protocols and UMTS terminals with a camera and a compatible video telephony client are a prerequisite for this.

Furthermore, in the network there are additional application servers, such as, for example, video servers which contain films in digital form for video on demand, or e-mail servers from which the STB can load e-mails for the user. Direct access to servers on the WWW/Internet is still possible. The STB has corresponding signaling relationships for each application according to the prior art. The control servers can also have appropriate signaling relationships with the application servers, e.g. for data comparison regarding the current status of available films.

1.-14. (canceled)

15. A IP-enabled terminal that interfaces with a TV, comprising:
a video-based entertainment service component;
a video-based communication service component; and
a shared operating system that allows parallel processing,
wherein the video-based entertainment service component includes a entertainment application,
wherein the video-based communication service includes a communication application, and
wherein the applications run in parallel on the shared operating system.

16. The terminal as claimed in claim 15, further comprising a video camera.

17. The terminal as claimed in claim 15, further comprising a video camera connection.

18. The terminal as claimed in claim 15, further comprising a loudspeaker and a microphone.

19. The terminal as claimed in claim 15, further comprising a DSL connector or a cable connector.

20. The terminal as claimed in claim 15, further comprising a USB connector.

21. The terminal as claimed in claim 15, further comprising an Ethernet connector.

22. The terminal as claimed in claim 15, further comprising a keyboard connector.

23. The terminal as claimed in claim 15, further comprising an indicator lamp.

24. The terminal as claimed in claim 15, further comprising a remote control connection.

25. The terminal as claimed in claim 15, further comprising a loudspeaker and a microphone.

26. The terminal as claimed in claim 25, further comprising a DSL connector.

27. The terminal as claimed in claim 26, further comprising a USB connector.

28. The terminal as claimed in claim 27, further comprising a cable connector.

29. The terminal as claimed in claim 28, further comprising an Ethernet connector.

30. The terminal as claimed in claim 29, further comprising a keyboard connector.

31. The terminal as claimed in claim 30, further comprising an indicator lamp.

32. The terminal as claimed in claim 31, further comprising a remote control connection.
